(19) United States
(12) Patent Application Publication
(10) Pub. No.: US 2026/0095791 A1
(43) Pub. Date: Apr. 2, 2026

(54) METHODS FOR DYNAMIC SWITCHING OF BEAM REPORTING MODES

(71) Applicant: InterDigital Patent Holdings, Inc., Wilmington, DE (US)

(72) Inventors: Haseeb Ur Rehman, Winnipeg (CA); Young Woo Kwak, Woodbury, NY (US); Nazli Khan Beigi, Longueuil (CA); Prasanna Herath, Laval (CA); Shahab Hamidi-Rad, Sunnyvale, CA (US); Ahmed Mostafa, Ottawa (CA); Oumer Teyeb, Montreal (CA)

(73) Assignee: InterDigital Patent Holdings, Inc., Wilmington, DE (US)

(21) Appl. No.: 18/902,022

(22) Filed: Sep. 30, 2024

(51) Int. Cl. H04W 24/10; H04W 16/22

(52) U.S. Cl. CPC H04W 24/10; H04W 16/22

(57) ABSTRACT

An example Wireless Transmit/Receive Unit (WTRU) comprises a processor. The processor is configured to receive configuration information associated with at least one of a prediction set of beams or a measurement set of beams. The processor is further configured to select a beam subset from the at least one of the prediction set or the measurement set based on the configuration information. The processor is further configured to select a reporting method for reporting the beam subset from a plurality of reporting methods based on at least one of: a reporting configuration associated with a base station, payload sizes associated with the plurality of reporting methods, network coverage at the WTRU, a size of the beam subset, or content of the beam subset. The processor is further configured to send one or more reports associated with the selected beam subset using the selected reporting method.

### BACKGROUND

Traditional beam management procedures typically involve measuring and/or transmitting beams (e.g., all beams) in a cell to facilitate identification of a beam (e.g., best beam), receive channels, and/or signals.

### SUMMARY

An example Wireless Transmit/Receive Unit (WTRU) is described. The WTRU comprises a processor configured to receive configuration information associated with at least one of a prediction set of beams or a measurement set of beams. The processor is further configured to select, based on the configuration information, a beam subset from the at least one of the prediction set or the measurement set. The processor is further configured to select, from a plurality of reporting methods, a reporting method for reporting the beam subset based on at least one of: (i) a reporting configuration associated with a base station, (ii) payload sizes associated with the plurality of reporting methods, (iii) network coverage at the WTRU, (iv) a size of the beam subset, or (v) content of the beam subset. The processor is further configured to send, using the selected reporting method, one or more reports associated with the selected beam subset.

In examples, the processor is further configured to select the reporting method based on one or more thresholds. In examples, the received configuration information indicates one or more reference signal (RS) resource configurations for the at least one of the prediction set or the measurement set. In examples, the received configuration information indicates one or more of: a threshold for beam selection, a threshold for reporting method selection, or a maximum number of beams to be selected from the at least one of the prediction set or the measurement set as the beam subset. In examples, the processor is further configured to collect or predict reference signal (RS) measurements for the prediction set of beams or the measurement set of beams, where the one or more reports indicate at least one of the collected or predicted RS measurements. In examples, the processor is further configured to receive the reporting configuration of the base station, where the reporting configuration indicates to the WTRU to use the selected reporting method for sending reports to the base station. In examples, the processor is further configured to select the reporting method based on a first payload associated with sending the one or more reports using the selected reporting method being less than a second payload associated with sending the one or more reports using a different reporting method of the plurality of reporting methods. In examples, the processor is further configured to select a first reporting method for sending the one or more reports based on the size of the beam subset being greater than a first threshold and less than a second threshold. In examples, the processor is further configured to select a second reporting method for sending the one or more reports based on the size of the beam subset being greater than the second threshold, where the size of the beam subset corresponds to a number of beams in the beam subset. In examples, the processor is further configured to select the reporting method based on a signal-to-noise-ratio (SNR) at the WTRU being less than a threshold SNR, where the SNR is indicative of the network coverage at the WTRU. In examples, the processor is further configured to select a first reporting method for sending the one or more reports based on a beam quality associated with one or more beams in the beam subset being greater than a threshold. In examples, the processor is further configured to select a second reporting method for sending the one or more reports based on the beam quality being less than the threshold, where the content of the beam subset corresponds to the one or more beams in the beam subset.

In examples, the plurality of reporting methods includes one or more of a first reporting method for reporting based on channel state information reference signal resource indicator (CRI) or synchronization signal physical broadcast channel resource indicator (SSBRI), a second reporting method for bitmap-based reporting, a third reporting method for beam-group-based reporting, a fourth reporting method for CRI-range-based reporting, or a fifth reporting method for measurement set reporting. In examples, the processor is further configured to send, in the one or more reports, one or more CRIs or one or more SSBRIs associated with one or more beams in the selected beam subset based on the selected reporting method being the first reporting method. In examples, the processor is further configured to send, in the one or more reports, an indication of a number of beams in the selected beam subset. In examples, the processor is further configured to send, in the one or more reports, an indication of one or more beam identifiers (IDs) of one or more beams in the beam subset using a bitmap based on the selected reporting method being the second reporting method. In examples, the processor is further configured to send an indication of one or more beam groups associated with the selected beam subset based on the selected reporting method being the third reporting method, where the one or more reports indicate a beam group ID of a beam group associated with a highest quality measured beam or a highest quality predicted beam or a highest quality reference signal. In examples, the processor is further configured to send an indication of at least one of a smallest CRI (CRI-L) or a highest CRI (CRI-H) associated with at least one beam in the selected beam subset based on the selected reporting method being the fourth reporting method. In examples, the processor is further configured to send, using a bitmap, an indication of one or more remaining beams in the selected beam subset other than the at least one beam associated with the CRI-L or the CRI-H. In examples, the processor is further configured to send an indication of beam qualities of all beams in the measurement set based on the selected reporting method being the fifth reporting method. In examples, the processor is further configured to send an indication of the selected reporting method in a channel state information (CSI) report. In examples, the processor is further configured to select a physical uplink control channel (PUCCH) resource for sending the one or more reports based on the selected reporting method.

An example method performed by a WTRU is described. The method comprises receiving configuration information associated with at least one of a prediction set of beams or a measurement set of beams. The method further comprises selecting, based on the configuration information, a beam subset from the at least one of the prediction set or the measurement set. The method further comprises selecting, from a plurality of reporting methods, a reporting method for reporting the beam subset based on at least one of: (i) a reporting configuration associated with a base station, (ii) payload sizes associated with the plurality of reporting methods, (iii) network coverage at the WTRU, (iv) a size of the beam subset, or (v) content of the beam subset. The method further comprises sending, using the selected reporting method, one or more reports associated with the selected beam subset.

In examples, the method further comprises selecting the reporting method further based on one or more thresholds. In examples, the received configuration information indicates one or more RS resource configurations for the at least one of the prediction set or the measurement set. In examples, the received configuration information indicates one or more of: a threshold for beam selection, a threshold for reporting method selection, or a maximum number of beams to be selected from the at least one of the prediction set or the measurement set as the beam subset. In examples, the method further comprises collecting or predicting RS measurements for the prediction set of beams or the measurement set of beams, where the one or more reports indicate at least one of the collected or predicted RS measurements. In examples, the method further comprises receiving the reporting configuration of the base station, where the reporting configuration indicates to the WTRU to use the selected reporting method for sending reports to the base station. In examples, the method further comprises selecting the reporting method based on a first payload associated with sending the one or more reports using the selected reporting method being less than a second payload associated with sending the one or more reports using a different reporting method of the plurality of reporting methods. In examples, the method further comprises selecting a first reporting method for sending the one or more reports based on the size of the beam subset being greater than a first threshold and less than a second threshold. In examples, the method further comprises selecting a second reporting method for sending the one or more reports based on the size of the beam subset being greater than the second threshold, where the size of the beam subset corresponds to a number of beams in the beam subset. In examples, the method further comprises selecting the reporting method based on a SNR at the WTRU being less than a threshold SNR, where the SNR is indicative of the network coverage at the WTRU. In examples, the method further comprises selecting a first reporting method for sending the one or more reports based on a beam quality associated with one or more beams in the beam subset being greater than a threshold. In examples, the method further comprises selecting a second reporting method for sending the one or more reports based on the beam quality being less than the threshold, where the content of the beam subset corresponds to the one or more beams in the beam subset.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

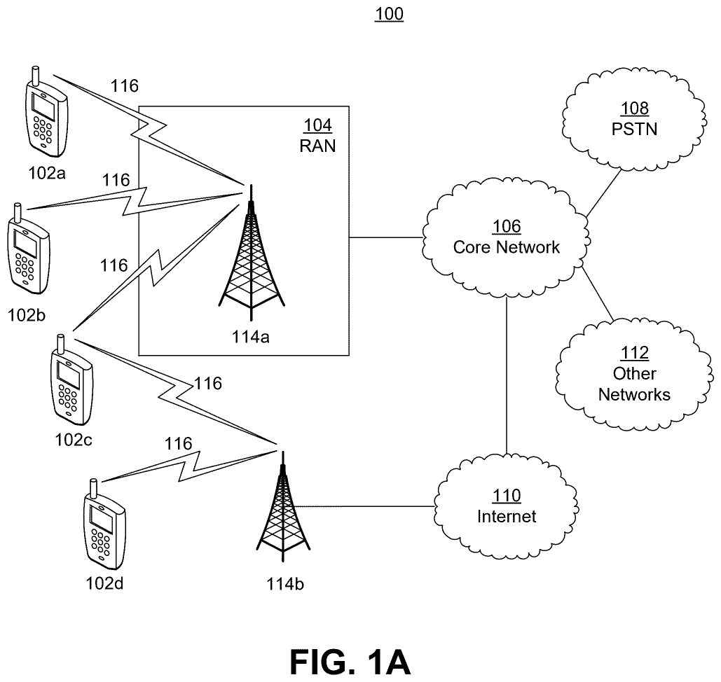

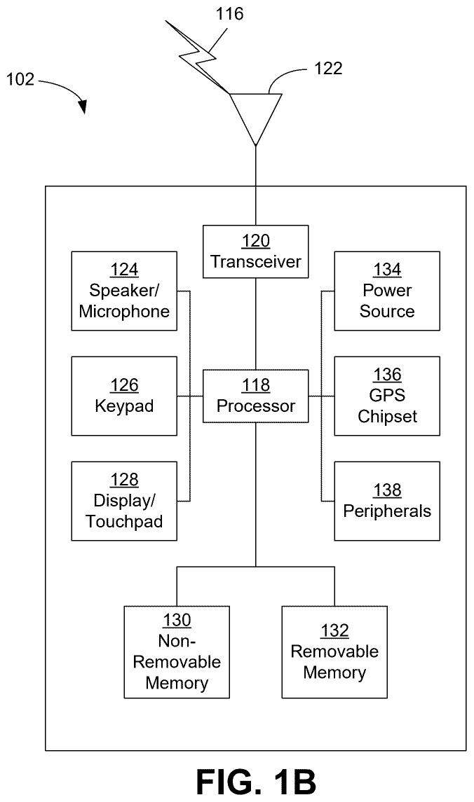

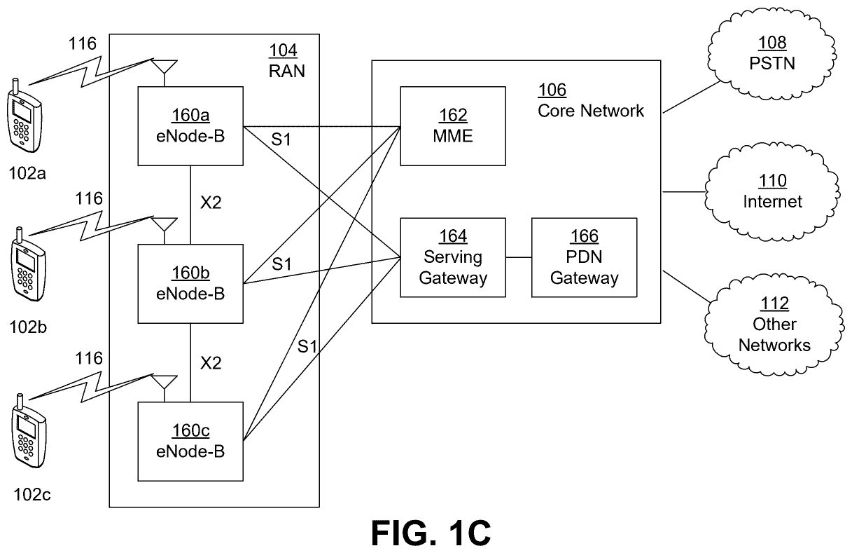

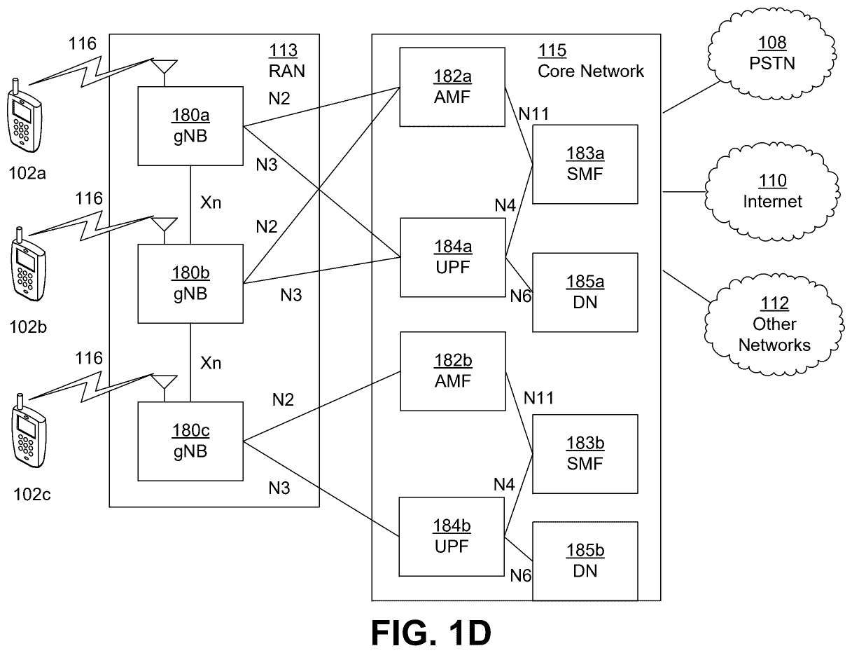

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples are described herein for beam management procedures associated with artificial intelligence (AI)/machine learning (ML) for New Radio (NR) air interfaces. Example beam management processes are described herein for downlink (DL) transmit (Tx) beam prediction for WTRU-sided models, network sided (NW-sided) models, and/or both WTRU-sided models and NW-sided models. Examples are described herein for spatial-domain DL Tx beam prediction for Set A of beams based on measurement results of Set B of beams (“BM-Case1”). Examples are described herein for temporal DL Tx beam prediction for Set A of beams based on the historic measurement results of Set B of beams (“BM-Case2”). The term “Set A of beams” and “prediction set of beams” may be interchangeably used herein. The term “Set B of beams” and “measurement set of beams” may be interchangeably used herein. Examples are described herein for specifying signalling/mechanisms (e.g., necessary signalling/mechanisms) to facilitate lifecycle management (LCM) operations specific to one or more Beam Management use cases. Examples described herein include enabling methods to facilitate (e.g., ensure) consistency between training and inference regarding NW-side additional conditions (e.g., if identified) for inference at a WTRU. Examples are described herein for a common framework design to support BM-Case1 and BM-Case2.

In traditional beam management procedures, beams (e.g., all the beams) in a cell may be transmitted and/or measured to identify a beam (e.g., best beam), receive channels, and/or signals. However, in AI/ML based DL Tx beam prediction, reference signals (RSs) for one or more selected beams may be transmitted, and an AI/ML model may estimate qualities of other beams based on measurements of the selected beams. This technology could enable improving performance and complexity of conventional beam management aspects, such as, for example, beam prediction in time, spatial domain for overhead and latency reduction, beam selection accuracy improvement, and/or other improvements.

An example use case for AI/ML with respect to beam management in the present disclosure may be to predict one or more best beams from a set of beams with improved accuracy and/or less overhead than legacy beam management procedures. Another example use case for AIML with respect to beam management may be to predict qualities of beams (e.g., including unmeasured beams) based on measured qualities of beams. In some beam management implementations, a WTRU may measure the RS signals to determine the beam quality and/or to report certain beam(s) (e.g., best beam(s)) among the measured beams. In contrast, an AI/ML model in a WTRU (e.g., or in a base station such as a gNB) may predict one or more beams out of a plurality of possible beams (e.g., including those not measured by the WTRU or gNB). An AI/ML model may also predict beam qualities of unmeasured beams. The input to the AI/ML model may be a set of beam measurements associated with a set of reference signals. The input set may be referred to as Set B. The AI/ML model may predict one or more beams (e.g., a best beam, a beam index, etc.) and/or qualities of the one or more beams from an output predicted set of beams (e.g., Set A). In this example, Set B may be a subset of Set A. An AIML model at the NW-side may use (e.g., or need) beam identifiers (IDs) and/or beam measurements by the WTRU as input to the model for performing training and/or inference. For a WTRU-side model, the WTRU may periodically transmit a beam report which may contain, for example, Top-K predicted beam IDs. The WTRU may also (e.g., periodically) transmit measurements associated with Set A (e.g., prediction set). In some instances, this may result in a large reporting overhead for the WTRU, such as (e.g., and/or especially) for BM-case2 scenarios where the measurement set (e.g., Set B) is large for example. Accordingly, example procedures are described herein for efficiently indicating and/or reporting beam IDs in a beam report so that reporting overhead can be reduced (e.g., minimized).

Current techniques (e.g., specifications) for beam management may involve a WTRU measuring RS signals associated with a beam, and using the measured RS signals to determine beam quality. For example, the WTRU may use the measured RS signals to determine and/or to report beam(s) (e.g., best beam(s)) among the measured beams.

A NW-side AI/ML model may use beam IDs and/or beam measurements from the WTRU as input to the model for performing training and inference. For WTRU-side model, the WTRU may periodically transmit a beam report which indicates one or more top (e.g., Top-K) predicted beam IDs. The WTRU may also periodically transmit measurements associated with Set A (e.g., prediction set). However, in some scenarios, this may result in a large reporting overhead for the WTRU, especially for BM-case2 where the measurement set (Set B) is large, for example. Accordingly, example procedures are described herein to efficiently indicate and/or report beam IDs in a beam report (e.g., as needed, etc.) so that the reporting overhead is reduce (e.g., minimized). Thus, examples described herein may provide solutions for reducing (e.g., minimizing) beam reporting overhead.

Within examples described herein, a WTRU may receive configuration information for RSs associated with a measurement set of beams, a prediction set of beams, and/or WTRU reports. Based on reference signal (RS) measurements, the WTRU may predict beams and/or reference signal received powers (RSRPs). The WTRU may indicate measured and/or predicted beams using one of a plurality of possible reporting methods, such as CRI-based reporting, Bitmap-based reporting, Beam-group based reporting, and/or CRI-range based reporting. The WTRU may select a reporting method based on received configuration information, payload size associated with each reporting method, one or more thresholds, and/or coverage (e.g., network coverage at the WTRU), for example. The WTRU may report beam/RS IDs and/or associated measured or predicted beam qualities using the selected reporting method.

By way of example, a WTRU may receive configuration information associated with at least one of a prediction set of beams (e.g., Set A) or a measurement set of beams (e.g., Set B). The WTRU may receive a configuration of one RS resource set including RS resource configurations for both Set A and Set B (e.g., indication of Set A/Set B resource received through RS resource config). Alternatively or additionally, the WTRU may receive a configuration of two or more RS resource sets associated with Set A and/or Set B. Thus, the received configuration information may indicate one or more RS resource configurations for the at least one of the prediction set of beams or the measurement set of beams. The received configuration information may include one or more report configurations. An example report configuration may include threshold(s) for beam selection: (e.g., X dB margin RSRP threshold, RSRP threshold, etc.). Another example report configuration may include threshold(s) for selecting reporting methods (e.g., number of beams thresholds). Another example report configuration may include a maximum number of beams (M) to report. Thus, the received configuration information may indicate a threshold for beam selection, a threshold for reporting method selection, and/or a maximum number of beams to be selected from the at least one of the prediction set or the measurement set (e.g., as a beam subset) for reporting.

The WTRU may collect or predict RS measurements for the prediction set of beams or the measurement set of beams. For example, the WTRU may perform measurements on RSs associated with Set B and/or Set A. The WTRU may measure or predict beam qualities (e.g., RSRP, signal-to-interference-noise-ratio (SINR), signal-to-noise-ratio (SNR), noise power, etc.) for RSs associated with Set B and/or Set A based on RS measurements (e.g., measurements performed on RSs associated with Set B).

Based on the received configuration information, the WTRU may select a beam subset from the at least one of the prediction set or the measurement set. For example, the WTRU may select a subset (e.g., beam subset, report-beams set, report set, etc.) of measured beams, predicted beams, measured RS, predicted RS, and/or associated measured/predicted RSRPs, etc., to include in WTRU report (e.g., based on a configured selection threshold).

The WTRU may select and/or determine a reporting method (e.g., from a plurality of reporting methods) for reporting the beam subset based on one or more of a reporting configuration associated with a base station (e.g., gNB configuration), payload sizes associated with the plurality of reporting methods (e.g., payload size), network coverage at the WTRU (e.g., coverage), one or more thresholds, size of the beam subset (e.g., number of beams in the beam subset), or content of the beam subset (e.g., beam positions, beam IDs, beam quality of beams in the beam subset, selected RSs associated with the beam subset, etc.).

As an example for gNB-configuration-based-selection, the WTRU may report via a reporting method configured and/or indicated by a base station (e.g., gNB). For example, the WTRU may receive the reporting configuration of the base station (e.g., from the base station or from any other network entity). The received reporting configuration may indicate to the WTRU to use a particular reporting method for sending reports to a particular base station, for example.

As an example for payload size based selection, the WTRU may determine the payload size associated with each reporting method based on the size and content of the report-beams set (e.g., beam subset) to be reported (e.g., select a reporting method that reduces or minimizes the payload size, select a reporting method that has the lowest determined payload size, etc.). For instance, the WTRU may select the reporting method based on a first payload associated with sending one or more reports about the beam subset using the selected reporting method being less than a second payload associated with sending the one or more reports using a different reporting method of the plurality of reporting methods.

As an example for threshold based selection and/or subset-size-based-selection, if the size of the report-beams set is greater than a first threshold (P1), the WTRU may report using a first reporting method, and if the size of the report-beams set is greater than a second threshold (P2), the WTRU may report using a second reporting method, and so on. For example, the WTRU may select a first reporting method for sending the one or more reports based on the size of the beam subset being greater than a first threshold and less than a second threshold, and the WTRU may select a second reporting method for sending the one or more reports based on the size of the beam subset being greater than the second threshold. The size of the beam subset may correspond to a number of beams in the beam subset.

As an example of coverage based selection, in a low coverage (e.g., low signal-to-noise-ratio (SNR)) scenario, the WTRU may report with a reporting method that supports splitting into parts (e.g., two reports). For example, the WTRU may report using channel state information reference signal resource indicator (CRI) based reporting method in multiple reports by indicating a subset of CRIs in each report. For instance, the WTRU may select the reporting method based on a SNR at the WTRU being less than a threshold SNR, where the SNR is indicative of the network coverage at the WTRU.

As an example of size and/or content (e.g., selected RSs of report-beams set) based selection, the WTRU may select a first reporting method for sending the one or more reports based on a beam quality associated with one or more beams in the beam subset being greater than a threshold, and the WTRU may select a second reporting method for sending the one or more reports based on the beam quality being less than the threshold. In this example, the content of the beam subset corresponds to the one or more beams (e.g., beam quality of the specific beams selected in the beam subset used to select the reporting method).

Examples of the plurality of reporting methods include a first reporting method for reporting based on CRI or synchronization signal physical broadcast channel resource indicator (SSBRI), a second reporting method for bitmap-based reporting, a third reporting method for beam-group-based reporting, a fourth reporting method for CRI-range-based reporting, and/or a fifth reporting method for measurement set reporting.

As an example, for CRI/SSBRI based reporting (e.g., first reporting method), the WTRU may indicate the CRI/SSBRI(s) of the beams selected for reporting (e.g., the beam subset). For example, based on the selected reporting method being the first reporting, the WTRU may send (e.g., in one or more reports) one or more CRIs or one or more SSBRIs associated with one or more beams in the selected beam subset. Additionally or alternatively, for the first reporting method, the WTRU may send (e.g., in the one or more reports) an indication of a number of beams in the selected beam subset.

As an example for bitmap based reporting (e.g., second reporting method), the WTRU may indicate beam IDs via a bitmap (e.g., bitmap of size equal to the number of beams and/or RSs configured for measurements). For example, the WTRU may report CRI/SSBRI, associated quality (e.g., RSRP) of a highest RSRP measured, and/or Top-1 predicted beam, etc. Thus, based on the selected reporting method being the second reporting method, the WTRU may send (e.g., in the one or more reports) an indication of one or more beam IDs of one or more beams in the beam subset using a bitmap.

As an example for beam group-based reporting (e.g., third reporting method), the WTRU may send an indication indicating beam-group IDs of beam groups associated with the report-beams set. The WTRU may indicate beams within a beam-group using beam-group specific CRI (e.g., for each indicated beam-group). For example, the WTRU may send an indication indicating the beam-group ID of the beam-group associated with highest quality measured beam, predicted beam, and/or RS. Thus, based on the selected reporting method being the third reporting method, the WTRU may send an indication of one or more beam groups associated with the selected beam subset, and the WTRU may send one or more reports to indicate a beam group ID of a beam group associated with a highest quality measured beam or a highest quality predicted beam or a highest quality RS.

As an example for CRI range-based reporting, based on the selected reporting method being the fourth reporting method, the WTRU may send an indication of at least one of a smallest CRI (CRI-L) or a highest CRI (CRI-H) associated with at least one beam in the selected beam subset. And the WTRU may send, using a bitmap, an indication of one or more remaining beams in the selected beam subset other than the at least one beam associated with the CRI-L or the CRI-H. For example, the WTRU may indicate the smallest CRI (CRI_L) and the highest or largest CRI (CRI_H) included in the report-beam set (e.g., selected beam subset). The WTRU may indicate remaining beams in the report-beam set via bitmap of size (CRI_H-CRI_L−1). For example, the mapping of beams to the bitmap may be offset by the indicated CRI_L. For example, Bit #0 of the bitmap may map to beam #CRI_L+1, and Bit #n may map to beam #CRI_L+n+1.

As an example for reporting entire measurement set, based on the selected reporting method being the fifth reporting method, the WTRU may send an indication of beam qualities of all beams in the measurement set. For example, the WTRU may send a 1-bit indication indicating that the qualities of beams (e.g., all the beams) in the configured measurement/RS resource set are reported. In an example, the WTRU may report beam qualities in order of CRIs, beam IDs, and/or RS IDs.

The WTRU may send, using the selected reporting method, one or more reports associated with the selected beam subset. For example, the WTRU may transmit the selected report-beams set using the selected reporting method (e.g., method associated with the smallest payload size, etc.). The WTRU may send an indication of the selected reporting method implicitly (e.g., based on physical uplink control channel (PUCCH) resource used for transmission) and/or explicitly (e.g., by including an explicit indication in a channel state information (CSI) Report). Thus, the WTRU may send an indication of the selected reporting method in a CSI report. Alternatively or additionally, the WTRU may select a PUCCH resource for sending the one or more reports based on the selected reporting method. The WTRU may indicate the number of beams associated with a WTRU report (e.g., for CRI based reporting).

Example solutions described herein may enable a WTRU to dynamically switch between different beam reporting methods to reduce (e.g., minimize) the WTRU beam reporting overhead (e.g., resource usage) in different resource configuration scenarios.

Hereinafter, ‘a’ and ‘an’ and similar phrases may be interpreted as ‘one or more’ and ‘at least one’ without departing from the scope of the present disclosure. Similarly, any term which ends with the suffix ‘(s)’ may be interpreted as ‘one or more’ and ‘at least one’ without departing from the scope of the present disclosure. The term ‘may’ may be interpreted as ‘may, for example’ without departing from the scope of the present disclosure.

Artificial intelligence (AI) may be broadly defined herein as the behavior exhibited by machines. Such behavior may, for example, mimic cognitive functions to sense, reason, adapt and act.

Machine learning (ML) may refer to type of algorithms that solve a problem based on learning through experience (e.g., ‘data’), without explicitly being programmed (e.g., ‘configuring set of rules’). Machine learning can be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep learning may refer to a class of machine learning algorithms that employ artificial neural networks (e.g., Deep Neural Networks (DNNs)) which were loosely inspired from biological systems. DNNs are a special class of machine learning models inspired by human brain wherein the input may be linearly transformed and pass-through non-linear activation function multiple times. DNNs typically consists of multiple layers where each layer consists of linear transformation and a given non-linear activation functions. The DNNs can be trained using the training data via back-propagation algorithm. Recently, DNNs have shown state-of-the-art performance in variety of domains, e.g., speech, vision, natural language etc. and for various machine learning settings supervised, un-supervised, and semi-supervised. The term AIML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

Example beam definitions are described herein. A WTRU may transmit or receive a physical channel or reference signal according to at least one spatial domain filter. The term “beam” may be used to refer to a spatial domain filter, for example.

The WTRU may transmit a physical channel or signal using the same spatial domain filter as the spatial domain filter used for receiving an RS (e.g., channel state information reference signal (CSI-RS)) or a synchronized signal (SS) block. The WTRU transmission may be referred to as “target”, and the received RS or SS block may be referred to as “reference” or “source.” In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (e.g., or “source”), respectively. In such case, the WTRU may be said to transmit the first (target) physical channel or signal according to a spatial relation with a reference to the second (reference) physical channel or signal.

A spatial relation may be implicit, configured by radio resource control (RRC) or signaled by medium access control control (MAC) control element (CE) or Downlink Control information (DCI). For example, a WTRU may implicitly transmit Physical Uplink Shared Channel (PUSCH) and/or DeModulation Reference Signal (DM-RS) of PUSCH according to the same spatial domain filter as a sounding reference signal (SRS) indicated by an SRS Resource Indicator (SRI) indicated in DCI or configured by RRC. In another example, a spatial relation may be configured by RRC for an SRI or signaled by MAC CE for a PUCCH. Such spatial relation may also be referred to as a “beam indication.”

The WTRU may receive a first (target) downlink channel or signal according to the same spatial domain filter or spatial reception parameter as a second (reference) downlink channel or signal. For example, such association may exist between a physical channel such as Physical Downlink Control Channel (PDCCH) or Physical Downlink Shared Channel (PDSCH) and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication.”

Hereafter, a transmission and reception point (TRP) may be interchangeably used with reference to one or more of transmission point (TP), reception point (RP), radio remote head (RRH), distributed antenna (DA), base station (BS), a sector (of a BS), and/or a cell (e.g., a geographical cell area served by a BS), without departing from the scope of the present disclosure. Hereafter, Multi-TRP may be interchangeably used with one or more of MTRP, M-TRP, and/or multiple TRPs, without departing from the scope of the present disclosure.

Examples are described herein for CSI components. A WTRU may report a subset of channel state information (CSI) components, where CSI components may correspond to at least a CSI-RS resource indicator (CRI), a synchronization signal block (SSB) resource indicator (SSBRI), an indication of a panel used for reception at the WTRU (such as a panel identity or group identity), measurements such as L1-RSRP, L1-SINR taken from SSB or CSI-RS (e.g. CRI-RSRP, CRI-SINR, CRI-Index-RSRP, SSB-Index-SINR), other channel state information such as at least rank indicator (RI), channel quality indicator (CQI), precoding matrix indicator (PMI), Layer Index (LI), and/or the like.

Examples are described herein for Channel and/or Interference Measurements. In an example for SSB, a WTRU may receive a synchronization signal/physical broadcast channel (SS/PBCH) block. The SS/PBCH block (SSB) may include a primary synchronization signal (PSS), secondary synchronization signal (SSS), and/or physical broadcast channel (PBCH). The WTRU may monitor, receive, or attempt to decode an SSB during initial access, initial synchronization, radio link monitoring (RLM), cell search, cell switching, and so forth. As an example for CSI-RS, a WTRU may measure and report the CSI, where the CSI for each connection mode may include or be configured with one or more of CSI report configuration(s), CSI-RS resource set(s), and/or Non Zero Power (NZP) CSI-RS Resources.

Examples for CSI Report Configuration include one or more of CSI report quantity (e.g., Channel Quality Indicator (CQI), Rank Indicator (RI), Precoding Matrix Indicator (PMI), CSI-RS Resource Indicator (CRI), Layer Indicator (LI), etc.), CSI report type (e.g., aperiodic, semi persistent, periodic), CSI report codebook configuration (e.g., Type I, Type II, Type II port selection, etc.), and/or CSI report frequency.

Examples for a CSI-RS Resource Set include one or more CSI Resource settings, such as NZP-CSI-RS Resource for channel measurement, NZP-CSI-RS Resource for interference measurement, and/or CSI-IM Resource for interference measurement.

Example for NZP CSI-RS Resources include one or more of NZP CSI-RS Resource ID, Periodicity and/or offset, QCL Info and/or TCI-state, and/or Resource mapping (e.g., number of ports, density, Code Division Multiplexing (CDM) type, etc.).

A WTRU may indicate, determine, and/or be configured with one or more reference signals. The WTRU may monitor, receive, and/or measure one or more parameters based on the respective reference signals. The following parameters are non-limiting examples of the parameters that may be included in reference signal(s) measurements. One or more of these parameters may be included. Other parameters may be included.

An example parameter may be SS reference signal received power (SS-RSRP). SS-RSRP may be measured based on the synchronization signals (e.g., DM-RS in PBCH or SSS). SS-RSRP may be defined as the linear average over the power contribution of the resource elements (RE) that carry the respective synchronization signal. In measuring the RSRP, power scaling for the reference signals may be required. In case SS-RSRP is used for Layer One RSRP (L1-RSRP), the measurement may be accomplished based on CSI reference signals in addition to or instead of the synchronization signals.

Another example parameter may be CSI-RSRP. CSI-RSRP may be measured based on the linear average over the power contribution of the resource elements (RE) that carry the respective CSI-RS. The CSI-RSRP measurement may be configured within measurement resources for the configured CSI-RS occasions.

Another example parameter may be SS signal-to-noise and interference ratio (SS-SINR). SS-SINR may be measured based on the synchronization signals (e.g., DM-RS in PBCH or SSS). SS-SINR may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

Another example parameter may be CSI-SINR. CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Alternatively or additionally, the noise and interference power may be measured based on the resources that carry the respective CSI-RS.

Another example parameter may be received signal strength indicator (RSSI). RSSI may be measured based on the average of the total power contribution in configured OFDM symbols and/or bandwidth. The power contribution may be received from different resources (e.g., co-channel serving and non-serving cells, adjacent channel interference, thermal noise, etc.).

Another example parameter may be Cross-Layer interference received signal strength indicator (CLI-RSSI). CLI-RSSI may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth)

Another example parameter may be Sounding reference signals RSRP (SRS-RSRP). SRS-RSRP may be measured based on the linear average over the power contribution of the resource elements (RE) that carry the respective SRS.

Example Beam and/or CSI Report Configurations are described herein. A CSI report configuration (e.g., CSI-ReportConfigs) may be associated with a single bandwidth part (BWP) (e.g., indicated by BWP-Id), where one or more parameters are configured. A non-exhaustive list of example parameters include CSI-RS resources and/or CSI-RS resource sets for channel and interference measurement, CSI-RS report configuration type (e.g., including periodic, semi-persistent, and/or aperiodic), CSI-RS transmission periodicity for periodic and/or semi-persistent CSI reports, CSI-RS transmission slot offset (e.g., for periodic, semi-persistent and/or aperiodic CSI reports), CSI-RS transmission slot offset list (e.g., for semi-persistent and/or aperiodic CSI reports), Time restrictions (e.g., for channel and/or interference measurements), report frequency band configuration (e.g., wideband/subband CQI, PMI, etc.), thresholds and/or modes of calculations for reporting quantities (e.g., CQI, RSRP, SINR, LI, RI, etc.), codebook configuration, group based beam reporting, CQI table, subband size, non-PMI port indication, Port Index, and so forth.

Example CSI-RS Resource Configurations are described herein. A CSI-RS Resource Set (e.g., NZP-CSI-RS-ResourceSet) may include one or more CSI-RS resources (e.g., NZP-CSI-RS-Resource, CSI-ResourceConfig, etc.). As examples of configurations for a WTRU in a CSI-RS resource, the WTRU may be configured with one or more of CSI-RS periodicity and/or slot offset (e.g., for periodic and/or semi-persistent CSI-RS Resources), CSI-RS resource mapping (e.g., to define the number of CSI-RS ports, density, CDM-type, OFDM symbol, and/or subcarrier occupancy), the bandwidth part to which the configured CSI-RS is allocated, and/or the reference to the TCI-State including the QCL source RS(s) and/or the corresponding QCL type(s).

Example RS resource set Configurations are described herein. One or more configurations may be used for a RS resource set. A WTRU may be configured with one or more RS resource sets. The RS resource set configuration may include one or more of RS resource set ID, one or more RS resources for the RS resource set, repetition (e.g., on or off), aperiodic triggering offset (e.g., one of 0-6 slots), and/or tracking reference signal (TRS) information (e.g., true or not).

Example RS resource Configurations are described herein. One or more configurations may be used for a RS resource. A WTRU may be configured with one or more RS resources. The RS resource configuration may include one or more of RS resource ID, Resource mapping (e.g., REs in a Physical Resource Block (PRB)), power control offset (e.g., one value of −8, . . . , 15), power control offset with SS (e.g., −3 dB, 0 dB, 3 dB, 6 Db), scrambling ID, periodicity and/or offset, and/or QCL information (e.g., based on a TCI state).

Examples for property of a grant or assignment are described herein. A property of a grant or assignment may include at least one of a frequency allocation, an aspect of time allocation (e.g., a duration), a priority, a modulation and/or coding scheme, a transport block size, a number of spatial layers, a number of transports blocks, a TCI state (e.g., CRI or SRI), a number of repetitions, whether a repetition scheme is Type A or Type B, grant type (e.g., whether the grant is a configured grant type 1, type 2, or a dynamic grant), whether the assignment is a dynamic assignment or a semi-persistent scheduling (e.g., configured) assignment, a configured grant index or a semi-persistent assignment index, a periodicity of a configured grant or assignment, a channel access priority class (CAPC), and/or any parameter provided in a DCI (e.g., by MAC or by RRC) for the scheduling the grant or assignment.

In some examples, an indication by DCI may include at least one of an explicit indication by a DCI field or by Radio Network Temporary Identifier (RNTI) used to mask Cyclic Redundancy Check (CRC) of the PDCCH, an implicit indication by a property (e.g., DCI format, DCI size, Coreset or search space, Aggregation Level, and/or a first resource element of the received DCI such as an index of first Control Channel Element). The mapping between a property and a value may be signaled by RRC or MAC.

Hereafter, RS may be interchangeably used with one or more of RS resource, RS resource set, RS port and RS port group, without departing from the scope of the present disclosure. Hereafter, RS may be interchangeably used with one or more of SSB, CSI-RS, SRS, DM-RS, TRS, Positioning Reference Signal (PRS), and/or Phase Tracking Reference Signal (PTRS), without departing from the scope of the present disclosure. Hereafter, a reference signal (RS) may be interchangeably used with one or more of sounding reference signal (SRS), channel state information-reference signal (CSI-RS), demodulation reference signal (DM-RS), phase tracking reference signal (PT-RS), and/or synchronization signal block (SSB), without departing from the scope of the present disclosure.

Hereafter, the term “channel” may be interchangeably used with one or more of PDCCH, PDSCH, Physical uplink control channel (PUCCH), Physical uplink shared channel (PUSCH)

Physical random access channel (PRACH), etc., without departing from the scope of the present disclosure.

A key performance indicator (KPI) may refer to, but not limited to, one or more of signal quality (e.g., L1-RSRP, SINR, CQI, RSSI, Reference Signal Receive Quality (RSRQ)), prediction performance (e.g., Percentage of the Top-1 genie-aided (i.e., best) beam is one of the Top-K predicted beams), link quality (e.g., throughput, block error rate (BLER)), data distribution (e.g., mean and/or variance of measured and/or predicted beam measurements), and/or RSRP (e.g., L1-RSRP) difference (i.e., the difference between measured and predicted RSRP of a beam).

Hereafter, a signal, channel, and/or message (e.g., as in DL or uplink (UL) signal, channel, and message) may be used interchangeably, without departing from the scope of the present disclosure. Hereafter, a RS resource set may be interchangeably used with a RS resource and/or a beam group, without departing from the scope of the present disclosure. Hereafter, beam reporting may be interchangeably used with CSI measurement, CSI reporting and/or beam measurement, without departing from the scope of the present disclosure. Hereafter, example solutions for beam resources prediction described herein may be used for beam resources belonging to a single or multiple cells as well as single or multiple TRPs, without departing from the scope of the present disclosure. Hereafter, CSI reporting may be interchangeably used with CSI measurement, beam reporting, and/or beam measurement, without departing from the scope of the present disclosure. Hereafter, a RS resource set may be interchangeably used with a beam group, without departing from the scope of the present disclosure. Hereafter, a Set B may be interchangeably used with a set of RS resource sets, beams, beam-pairs, beam RS resources, RS resources, and/or a beam pattern. Hereafter, Set B may be interchangeably used with measurement RS resources, measurement RS resource set, measurement beam resources, measurement beam resource set, measurement beam pattern, measurement TCI states, and/or measurement TCI state group, etc., without departing from the scope of the present disclosure. Hereafter, a Set A may be interchangeably used with a set of RS resource sets, beams, beam-pairs, beam RS resources, RS resources, and/or a beam pattern. Hereafter, beam prediction accuracy may be interchangeably used with prediction accuracy, without departing from the scope of the present disclosure.

Example methods to configure measurement resources and/or report parameters are described herein. In an example, a WTRU may receive configuration information indicating one or more configurations (e.g., via RRC, via MAC CE, and/or via DCI).

The configuration information may include a configuration of one RS resource set, where one or more RS resources of the RS resource set may be associated with one or more of Set B, Set A, and/or neither Set A nor Set B. The association of an RS resource with Set B and/or Set A may be configured via RRC (e.g., via one or more parameters inside RS-ResourceConfig and/or RS-ResourceSetConfig), MAC-CE, and/or DCI (e.g., a bitmap-based activation and/or indication of association of RS resources with Set B and/or Set A). The configuration information may include a configuration of two or more RS resource Sets (e.g., where each RS resource set is associated to either Set B or Set A).

The configuration information may include a configuration of one or more report parameters (e.g., CSI-Report parameters, Beam report parameters, etc.). As an example of the report parameter(s) (e.g., report method), the WTRU may receive an indication and/or configuration parameter for beam and/or RS indication method, where a first value of the parameter may indicate to the WTRU to use the first reporting method and a second value of the parameter may indicate to the WTRU to use a second reporting method (e.g., for beam/RS indication), and so on. As another example of the report parameter(s) (e.g., thresholds), the WTRU may be configured with one or more of RS/beam quality thresholds, and/or RS/beam selection thresholds. For example, the one or more parameters may indicate a RSRP-threshold, a threshold for (e.g., X dB) margin with the highest quality beam/RS, and/or one or more thresholds for LOS probability, CQI, SINR, etc. As another example of the report parameter(s) (e.g., report size parameters), the WTRU may receive a configuration of one or more report size parameters. A non-exhaustive list of example report size parameters includes number of beams (M) (e.g., measured beams) to be indicated in a CSI-Report and/or a beam report, number of predicted beams (K) to be indicated in a CSI-Report, number of temporal prediction instances (N) to be reported in one report, and/or a maximum payload size. As another example of the report parameter(s) (e.g., beam-groups), the WTRU may receive a configuration of one or more beam-groups, where one or more beams and/or RSs associated with a RS resource set may be assigned a beam-group for example. Alternatively or additionally, the WTRU may receive a configuration ID of a predefined configuration of beam-groups. In a solution, the WTRU may receive a same report configuration for multiple CSI-reports. In another solution, the WTRU may receive a different report configuration for each instance of CSI-Report.

The WTRU may perform measurements on RSs associated with Set B and/or Set A. Based on the measurements, the WTRU may determine measured beam qualities (e.g., RSRPs) of measured RSs associated with Set B and/or Set A. Based on the measurements associated with beams and/or RSs of Set B, for example, the WTRU may determine one or more of predicted best beams (e.g., beams with highest RSRP), and/or predicted qualities (e.g., RSRPs). For example for predicted best beams, the WTRU may predict beam indices of Top-K highest quality beams. As an example for predicted qualities (e.g., RSRPs), the WTRU may predict RSRPs of beams associated with Set A (e.g., also including Set B). Hereafter, a predicted beam quality and/or predicted RSRP may refer to a beam quality and/or RSRP associated with a beam (e.g., not obtained by directly measuring the RS associated with the beam (i.e., obtained by AIML model and/or through other filtering/signal processing techniques performed on RS measurements by the WTRU).

The WTRU may indicate and/or report a subset (e.g., report-beams set, beam subset, etc.) of beams from measured and/or predicted beams (e.g., all measured and/or predicted beams) based on measured and/or predicted beam qualities and/or configured thresholds. For example, the WTRU may indicate and/or report the top M measured beams/RSs with the highest quality, measured beams/RSs (e.g., up to M) whose measured quality (e.g., RSRP) is greater than a quality threshold, measured beams/RSs (e.g., up to M) whose measured quality is within X dB margin of the highest RSRP measured beam, the top K (e.g., Top-K) predicted beams (e.g., Top-K predicted beams determined based on predicted quality or predicted RSRPs), and/or measured and/or predicted RSRPs associated with one or more indicated measured/predicted beams/RSs.

Example beam reporting modes for indicating measured and/or predicted beams are described herein. In an example, the WTRU may indicate beams/RSs and/or associated measured/predicted RSRPs in the WTRU report (e.g., CSI-Report) using one or more reporting methods.

As an example of a first reporting method (e.g., CRI/SSBRI based reporting), the WTRU may indicate the CRIs/SSBRIs of one or more beams associated with the report-beams set. The report-beams set may be a resource set for predicted beams/RSs (e.g., Set B). The WTRU may report/transmit measured and/or predicted qualities (e.g., RSRPs) of the beams/RSs indicated in the WTRU report. Alternatively or additionally, for example, the WTRU may report measured and/or predicted quality (e.g., RSRP) for the highest measured/predicted RSRP indicated beam. The WTRU may send an indication of the number of beams indicated in the WTRU report.

As an example of a second reporting method (e.g., Bitmap-based reporting), the WTRU may indicate beams/RSs/beam IDs associated with the report-beams set using a bitmap. For example, the WTRU may indicate beams/RSs using a bitmap of the size of measurement/RS resource set, wherein each bit position of a bit map may correspond to beams/RSs in the measurement/RS resource set. For example, bit #1 may be associated to beam #1/RS #1, bit #n may be associated to beam #n/RS #n of the configured measurement/RS resource set, and so on. In another example, a first bit value (e.g., 1) of a bit position may indicate that the beam associated with that bit position is included in the report-beams set and a second bit value (e.g., 0) may indicate otherwise.

In a solution, the WTRU may transmit additional order/rank bits to indicate the relative beam/RS quality of the beams/RSs indicated by the bitmap. For example, the WTRU may indicate quality rank of beams/RSs via report-beams specific bitmap wherein CRI #1 may be associated to the first indicated beam (i.e., beam included in report-beams set), CRI #n may be associated to the nth indicated beam. The WTRU may transmit bitmap specific CRIs in order of beam/RS quality in the WTRU report.

In a solution, the WTRU may send an indication indicating the transmission of a new bitmap based on the report-beams set. For example, based on the condition that the report-beams set remains unchanged from the last WTRU report, the WTRU may decide to not transmit another (e.g., new) bitmap. For example, based on the condition that the report-beams set may be different from the last WTRU report, the WTRU may transmit a new bitmap. For example, the WTRU may send a 1-bit indication wherein a first value of the bit (e.g., 0) may indicate that a new bitmap may not be transmitted and the last transmitted bitmap in a WTRU report may be reused, and a second bit value (e.g., 1) may indicate transmission of a new bitmap in the current WTRU report.

In a solution, the WTRU may report/transmit measured and/or predicted qualities (e.g., RSRPs) of the beams/RSs indicated in the WTRU report (e.g., in order of beam IDs/RS IDs). In another solution, the WTRU may indicate/report the CRI/SSBRI and/or associated measured and/or predicted RSRP of the highest quality (e.g., RSRP, SINR) measured/predicted indicated beam.

In a solution (e.g., multiple-instance reporting), the WTRU may indicate beams associated with first reporting time instance using CRI/SSBRIs. The WTRU may indicate beams associated with the subsequent reporting time instances using a bitmap. For one or more reporting instances the WTRU may indicate the CRI/SSBRI and/or associated measured/predicted quality of the highest quality measured/predicted beam/RS.

As an example of a third reporting method (e.g., beam-group based reporting), the WTRU may assign the beams associated with measurement/RS resource set to one or more beam groups (e.g., based on received configuration and/or predefined configuration of beam-groups). In a solution, the WTRU may explicitly indicate one or more beam-group IDs associated to the beams included in report-beams set. Additionally or alternatively, the WTRU may indicate the beam-group IDs of the beam-group associated with the highest quality (e.g., RSRP) measured/predicted beam. In a solution, the WTRU may implicitly indicate one or more beam groups. For example, the WTRU may indicate a first group of beams (e.g., via CRIs with full size). Based on the indicated first group of CRIs, the WTRU may indicate a second group of beams within the beam groups associated with the first group of beams (e.g., via CRIs with size [round up(log₂ P)] where P is size [round up(log₂ P)] of the beam groups associated with the first group of beams. In a solution, the WTRU may indicate beams/RSs within a beam-group via beam-group specific CRI. For example, for a beam-group of size P beams/RSs, the WTRU may send a CRI of size [round up(log₂ P)] to indicate a beam within that beam-group. In a solution, the WTRU may transmit beam-group specific CRIs in order of beams/RSs quality (e.g., RSRP) associated with the CRIs. In a solution, the WTRU may receive a configuration/indication of one or more beam-group IDs. The WTRU may indicate beam-group specific CRIs of beams associated with the indicated/configured beam-groups IDs.

As an example of a fourth reporting method (e.g., reporting entire measurement set), the WTRU may report measured and/or predicted qualities (e.g., RSRPs) of all the beams/RSs associated with the configured measurement/RS resource set. The WTRU may report measured and/or predicted qualities in order of beam IDs/CRIs/SSBRIs/RS IDs. The WTRU may send an indication (e.g., 1-bit indication) indicating the report of all the beams/RSs associated with configured measurement/RS resource set.

As an example of a fifth reporting method (e.g., CRI range-based reporting), the WTRU may indicate one or more beams (e.g., RS resources) based on the reported CRI range associated to the report-beams set. For example, the WTRU may indicate a first CRI (e.g., CRI_L, a CRI value with the lowest CRI among the one or more beams) and a second CRI (e.g., CRI_H, a CRI value with a largest CRI index among the one or more beams). Based on the reported CRI range, the WTRU may indicate one or more beams associated to the report-beams set.

For example, the WTRU may indicate a bitmap for beams from (CRI_L to CRI_H). For example, the least significant bit (LSB) may indicate a bit for CRI_L+1 and the most significant bit (MSB) may indicate a bit for CRI_H-CRI_L−1, as depicted in the table below:

| | Bit #0 | | | Bit #[CRI_H − CRI_L − 1] |
|---|---|---|---|---|
| Bit | (LSB) | Bit #1 | . . . | (MSB) |
| Content | CRI_L + 1 | CRI_L + 2 | . . . | CRI_H − 1 |

In another example (e.g., CRIs), the WTRU may indicate one or more beams (e.g., RS resources) from CRI_L to CRI_H based on the reported CRI range. For example, the WTRU may indicate CRI_L+1 by activating (e.g., set to 1) bit #0, CRI_L+2 by activating bit #1 and CRI_H−1 by activating bit #[CRI_H-CRI_L−1], and so on.

Examples methods for reporting information based on a determined beam reporting mode are described herein. In an example, a WTRU may report information of the determined/configured reporting method based on one or more of one-part reporting (e.g., 1-part reporting), two-part reporting (e.g., 2-part reporting), and/or three-part reporting (e.g., 3-part reporting).

As an example for one-part reporting, the WTRU may indicate information (e.g., all the information) including one or more of a determined reporting method, CRIs/SSBRIs, a bit map, CRI ranges, measured L1-RSRPs/differential L1-RSRPs, and/or predicted L1-RSRPs/differential L1-RSRPs. In this example, the WTRU may determine a total payload size for the reporting by assuming maximum size. For example, a total payload size of a reporting method associated with (e.g., which requires) a largest payload among candidate reporting methods may be used. If actual information size is less than the payload size, the WTRU may use padding of bits. For example, fixed bits (e.g., zeros) may be padded in the front of one or more of the whole information.

As an example for two-part reporting, the WTRU may indicate first information group in a first part and second information group in a second part. The first part information may determine a payload size for the second information group, for example. In examples, the two-part reporting may be based on one or more different considerations. In an example, the first part may indicate a reporting method (e.g., one or more of CRI/SSBRI based reporting, bitmap based reporting, beam group based reporting, reporting entire measurement set, and/or CRI range based reporting) and the second part may indicate beam information based on the indicated reporting method. In another example, the first part may indicate number of beams in the report. The second part may indicate other beam related information (e.g., CRI/SSBRIs, bitmap and other information, beam group and corresponding qualities (e.g., L1-RSRP, L1-SINR and CQI)). Based on the first part, the size of the second group may be determined (e.g., based on number of beams). In another example, the first part may indicate a bitmap and order/rank related information and the second part may indicate qualities of the indicated beams. In another example, the first part may indicate beam groups to be reported and the second part may indicate beams in the indicated beam groups and/or qualities of the indicated beams. In another example, the first part may indicate a first CRI (e.g., lowest CRI) and a second CRI (e.g., highest CRI) and the second part may indicate one or more beams (e.g., based on CRIs/SSBRIs and/or a bitmap) and/or qualities of the indicated beams.

As an example for three-part reporting, the WTRU may indicate first information group in a first part, second information group in a second part, and third information group in a third part. In an example, the first part may indicate a reporting method (e.g., one or more of CRI/SSBRI based reporting, bitmap based reporting, beam group based reporting, reporting entire measurement set and CRI range based reporting), the second part may indicate number of beams in the report. The third part may indicate other beam related information (e.g., CRI/SSBRIs, bitmap and other information, beam group and corresponding qualities (e.g., L1-RSRP, L1-SINR and CQI)). Based on the second part, the size of the third group may be determined (e.g., based on number of beams). In another example, the first part may indicate a reporting method (e.g., one or more of CRI/SSBRI based reporting, bitmap based reporting, beam group based reporting, reporting entire measurement set and CRI range based reporting), the second part may indicate a bitmap and order/rank related information and the third part may indicate qualities of the indicated beams. In another example, the first part may indicate a reporting method (e.g., one or more of CRI/SSBRI based reporting, bitmap based reporting, beam group based reporting, reporting entire measurement set and CRI range based reporting), the second part may indicate beam groups to be reported and the third part may indicate beams in the indicated beam groups and/or qualities of the indicated beams.

In a solution, the WTRU may determine a payload size of a next part based on the information of one or more previous parts. Beam information may include one or more of CRI, SSBRI, RI, LI, PMI, L1-RSRP, L1-SINR, CQI, etc.

In a solution, the WTRU may determine a reporting structure (e.g., one of 1 part reporting, 2 part reporting, and/or 3 part reporting) and corresponding beam information based on a determined reporting method. For example, the WTRU may use a first reporting structure (e.g., 2 part reporting) if the WTRU is indicating a first reporting method. And the WTRU may use a second reporting structure (e.g., 3 part reporting) if the WTRU is indicating a second reporting method, and so on.

In a solution, the WTRU may determine a reporting structure (e.g., one of 1 part reporting, 2 part reporting, and/or 3 part reporting) and corresponding beam information based on configuration/activation of reporting method indication. For example, the WTRU may use a first reporting structure (e.g., 2 part reporting) if the WTRU is not configured/activated with reporting method indication. And the WTRU may use a second reporting structure (e.g., 3 part reporting) if the WTRU is configured/activated with reporting method indication, and so on.

Example methods for dynamic switching of beam reporting modes are described herein. Example methods for determining and/or selecting a beam reporting mode are described herein. In an example, a WTRU may determine a reporting method (e.g., one or more of CRI/SSBRI based reporting, bitmap based reporting, beam group based reporting, entire measurement set reporting, and/or CRI range based reporting). The WTRU may make the determination based on one or more conditions, indications, configurations, etc. For example, the WTRU may receive one or more corresponding configuration information and indications, for example, via one or more of RRC, MAC-CE, DCI, and/or SIB, etc.

Examples are described herein for reporting method selection based on received configurations and/or indications. For example, a WTRU may determine the reporting method to be used based on one or more of the received, (pre) configured, and/or (pre) indicated configuration information and/or indications. For example, the WTRU may receive the configurations and/or indications, for example, from a gNB. In an example, the WTRU may receive one or more indications on the reporting method to be used. To that end, one or more of periodic reporting, semi-persistent reporting, and/or aperiodic reporting may apply.

As a periodic reporting example, the WTRU may receive two or more reporting configurations. Each reporting configuration may be associated with a corresponding reporting method. For example, a first reporting configuration (e.g., with a first set of periodicity, offset and frequency resources, etc.) may be used for reporting based on a first reporting method. Similarly, the WTRU may use a second reporting configuration based on a second reporting method, and so on. Alternatively, for example, the WTRU may determine, be configured, and/or indicated to send the report based on different methods in alternates. That is, for example, the WTRU may use multiple sets of reporting instances wherein each set of reporting instance may be associated with each reporting method. For example, the WTRU may report the beam related information based on the first reporting method if the WTRU reports the beam information in a first set of reporting instances. The WTRU may report based on the second reporting method if the WTRU reports beam information in a second set of reporting instances.

As a semi-persistent reporting example, the WTRU may receive one or more first and second starting time, end time, time duration, time period values, etc. to be used for reporting based on a first and second reporting methods, respectively. In an example, the WTRU may receive two or more reporting configurations wherein each reporting configuration may be associated with each reporting method. For example, a first reporting configuration (e.g., with a first set of periodicity, offset and frequency resources) may be used for reporting based on a first reporting method, the WTRU may use a second reporting configuration based on a second reporting method, and so forth. Each reporting configurations may be activated/deactivated (e.g., via MAC CE and/or DCI). The WTRU may only report activated reporting configurations based on associated reporting methods. Alternatively, for example, the WTRU may determine, be configured, and/or indicated to send the report based on different methods in alternates. That is, for example, the WTRU may use multiple sets of reporting instances wherein each set of reporting instance may be associated with each reporting method. For example, the WTRU may report the beam related information based on the first reporting method if the WTRU reports the beam information in a first set of reporting instances. The WTRU may report based on the second reporting method if the WTRU reports beam information in a second set of reporting instances. Each set of reporting instances may be activated/deactivated (e.g., via MAC CE and/or DCI). The WTRU may report (e.g., only report) activated set of reporting instances based on associated reporting methods. In a solution, the WTRU may receive an indication of activation/deactivation (e.g., via MAC CE and/or DCI) for activating/deactivating reporting methods. Based on the indication, the WTRU may report beam related information associated based on the activated reporting methods based on associated reporting configurations/instances.

As an aperiodic reporting example, the WTRU may receive one or more indications (e.g., DCI) of reporting method on aperiodic reporting. An indication may be explicit (e.g., one bit for which a value of 0 corresponds to a first reporting method and a value of 1 a second reporting method, etc.) in DCI to explicitly indicate one, two, or more preconfigured reporting methods for a triggered CSI report configuration. Similarly, for example, N bits (e.g., where N>2) and 2\hat{ }N reporting methods may be used. Alternatively or additionally, an indication may be implicit. For example, each CSI report configuration may indicate whether to use a first reporting method or a second reporting method. In another example, a bitmap may be supported wherein each bit of the bitmap is associated with each set of CSI reporting configurations for aperiodic CSI trigger. For example, when a set of CSI report configurations is triggered, an associated bit with the set of CSI report configurations may indicate whether to use a first method or a second method. In another example, multiple bitmaps may be supported wherein each bitmap is associated with each CSI reporting configuration in an associated set of CSI reporting configurations for aperiodic CSI trigger. Each bit of the bitmap may indicate whether to use the first method or the second method. Size of the bitmap may be number of CSI report configurations in the associated set of CSI reporting configurations for aperiodic CSI trigger. Size of the bitmap may be maximum number of CSI report configurations in all associated set of CSI report configurations for aperiodic CSI trigger to the WTRU.

Examples are described herein for reporting method selection based on measurement. In an example, the WTRU may determine a reporting method based on measurement (e.g., quality of measurement (e.g., one or more of L1-RSRP, L1-SINR and CQI). For example, the WTRU may receive one or more threshold values and/or associated configurations. The WTRU may measure RSs (e.g., configured in the CSI resource configuration associated with the triggered CSI report configuration for the report). Based on the measurement, the WTRU may determine a reporting method. For example, if quality of the measurement is larger than a threshold, the WTRU may determine a first reporting method. If the quality of the measurement is smaller than (or equal to) the threshold, the WTRU may determine a second reporting method.

Examples are described herein for reporting method selection based on payload size. For example, a WTRU may determine the reporting method to be used based on reporting payload size. The WTRU may determine the payload size based on the reporting method, number of beams to be reported, beam IDs of the beams to be reported, and so forth. Hereafter, the parameter M may be used for denoting the number of the beams to be reported.

As an example for CRI/SSBRI based reporting, the WTRU may calculate, estimate, and/or determine the payload size for CRI/SSBRI based reporting. In an example, the WTRU may determine the payload size based on M bits multiplied by the number of bits for indicating a CRI (e.g., M×number of bits for indicating a CRI), where the number bits for indicating a CRI may be determined, for example based on round up (log₂ M).

As an example for bitmap based reporting, the WTRU may calculate, estimate, and/or determine the payload size for bitmap-based reporting. In an example, the WTRU may determine the payload size based on M bits required for bitmap indication in addition to the number of bits for indicating a CRI (e.g., for indication of the beam with the highest measured RSRP). Optionally, the WTRU may also add one or more bits for indication of the ordering of the beams. For example, the payload size may be calculated based on M+number of bits for indicating a CRI+optional ordering bits.

As an example for beam group-based reporting, the WTRU may calculate, estimate, and/or determine the payload size for beam group-based reporting based on the number of the beams to be reported, number of beam groups, number of bits needed for indicating beam group IDs, etc. Hereafter, the parameter B may be used for denoting the number of bits needed for indicating beam group ID. In an example, the WTRU may calculate the payload based on number of beam groups multiplied by B, in addition to B bits (e.g., to indicate the beam group including the beam with highest measured RSRP), in addition to M multiplied by the number of bits for indicating a CRI within a beam group. For example, the payload size may be calculated based on Number of beam groups×B bits+B bits (for indicating beam group that contains best beam)+M×number of bits of a CRI within a beam group.

As an example for CRI range-based reporting, the WTRU may calculate, estimate, and/or determine the payload size for CRI range-based reporting. In an example, the WTRU may determine the payload size based on the number of bits required for indicating a CRI (e.g., since the WTRU may indicate the highest and/or lowest CRI as part of the reporting procedure). In an example, the WTRU may calculate the payload based two times the number of bits for indicating a CRI in addition to corresponding bitmap bits that may be (highest CRI−lowest CRI−1) bits. For example, the payload size may be calculated based on 2×number of bits of a CRI+(highest CRI−lowest CRI−1) bits.

In a first example scenario, for a system with number of measured beams equal to 32, and number of beams to be reported equal to 16, the payload size may be calculated for the different reporting methods, as follows:

Payload size using CRI/SSBRI reporting method: 16 beams×5 bits=80 bits.

Payload size using bitmap reporting method: 32 bits+5 bits (CRI of best beam)=37 bits.

Payload size using beam-group based reporting method (assuming 4 beam groups 8 beams with beam report set spread out in 3 beam groups): 3×2 bits (beam group id)+2 bits (beam group of best beam)+16×3 (3-bit CRI for each beam)=56 bits.

Payload size using CRI-range based (assuming lowest CRI is beam #12 and highest CRI is beam #30) reporting method: 5 bits (lowest CRI)+5 bits (highest CRI)+17 (30-12-1)=27 bits.

According to the first example scenario described above, the CRI-range based reporting method has the lowest payload.

In a second example scenario, for a system with number of measured beams equal to 32, and number of beams to be reported equal to 4, the payload size may be calculated for the different reporting methods, as follows:

Payload size using CRI/SSBRI reporting method: 4 beams×5 bits=20 bits.

Payload size using bitmap reporting method: 32 bits+5 bits=37 bits.

Payload size using beam-group based reporting method (assuming 4 beam groups 8 beams and report set in 1 beam group): 2 bits+2 bits+4 beams×3 bits=14 bits.

Payload size using CRI-range based reporting method (assuming lowest CRI is beam #10 and highest CRI is beam #17): 5 bits+5 bits+6 bits (17−10−1)=16 bits.

According to the second example scenario described above, the beam group-based reporting method has the lowest payload.

Examples are described herein for reporting method selection based on thresholds. For example, a WTRU may determine the reporting method to be used based on one or more determined, indicated, and/or configured threshold values. In an example, the WTRU may receive one or more threshold values, for example from a Node-B (e.g., via one or more of SIB, RRC, MAC-CE, DCI, etc.).

An example threshold may be the number of beams to be reported. For example, a WTRU may determine, be configured, and/or indicated with one or more thresholds on the number of beams to be reported, based on which the WTRU may determine the reporting method to be used. In an example, if the number of beams to be reported is higher than a first threshold (e.g., >P1) the WTRU may report based on the first method. In another example, if the number of beams to be reported is lower than the first threshold and higher than a second threshold (e.g., >P2), the WTRU may report based on the second method, and so forth.

Another example threshold may pertain to the difference in the number of beams in measurement set versus report set (e.g., beam subset). For example, a WTRU may determine, be configured, and/or indicated with one or more threshold values on the difference between the number of the beams in the measurement set with the number of the beams in the report set. The WTRU may determine and/or calculate the difference between the number of the beams in the measurement set compared to the number of the beams in the report set. In an example, if the calculated difference is lower than a corresponding configured, indicated, and/or determined threshold, the WTRU may determine to report all the measurement beams. Otherwise, if the calculated difference is higher than the corresponding threshold, the WTRU may determine the reporting method based on one or more conditions, indications, and/or configurations, as described herein.

Another example threshold may pertain to payload size. For example, a WTRU may determine, be configured, and/or indicated with one or more threshold values on the payload size for reporting the beams. The WTRU may determine and/or calculate the payload size for different reporting methods, as described herein. In an example, if the calculated payload size is higher than a determined, configured, and/or indicated first threshold value (e.g., >S1), the WTRU may use the first reporting method. In another example, if the calculated payload size is lower than the first threshold value and higher than a determined, configured, and/or indicated second threshold value (e.g., >S2), the WTRU may use the second reporting method, and so forth.

Examples are described herein for reporting method selection based on coverage (e.g., network coverage). For example, a WTRU may determine the reporting method to be used based on capability of the WTRU, UL coverage of the WTRU, etc. In an example, the WTRU may use the UL power, SNR, UL block error rate (BLER), etc., along with one or more thresholds as the value for determining UL coverage of the WTRU. For example, if the UL power is higher than a corresponding threshold, the WTRU may determine that the WTRU may be having low coverage. In another example, the WTRU may measure, calculate, and/or determine SNR based on one or more DL RSs, where the WTRU may determine that the WTRU may be having low coverage if the determined SNR is lower than a corresponding threshold.

In an example, if the WTRU determines that the WTRU is having a low coverage, the WTRU may use a reporting method that allows dividing and/or splitting the information to be reported into different parts. For example, a WTRU with low coverage may use CRI-based reporting method while splitting the report in multiple reports. In an example, each part of the report may include one or more subsets of CRI-based reports. In another example, a WTRU with low coverage may use beam-group-based reporting method, where the report may be divided in different parts. Each part may include an indication of CRIs associated with one or more beam groups. In such cases with splitting the reports in multiple parts, for example, a first report part may include information on the total number of report parts and/or the payload of the next, following, upcoming, and/or other report parts.

Within examples, the determination and/or selection of the reporting method as described herein may apply for one or more of aperiodic reporting, semi-persistent reporting, and/or periodic reporting.

Example methods for indicating and/or reporting with a beam reporting mode are described herein. In an example, the WTRU may report predicted and/or measured beam quality (e.g., L1-RSRP) and/or identities (e.g., CSI or SSBRI) of selected set of beams (e.g., of top-K beams) based on a reporting method selected or indicated by gNB (e.g., via one or more of RRC signaling, MAC-CE indication, DCI indication). In an example, where the WTRU selects a method for beam reporting, the WTRU may indicate (e.g., to the gNB) the selected reporting method. To that end, the WTRU may use one or more solutions for indicating the selected reporting method.

In a solution, the WTRU may indicate the selected reporting method to gNB as a part of beam report. For example, the WTRU may be configured (e.g., via one or more of RRC signaling, MAC-CE indication, DCI indication, etc.) with a set of reporting methods and each reporting method in the set of reporting methods may be identified by an ID (e.g., based on the position in the set such as first position, second position, etc.). The WTRU may report the ID of the selected reporting method as a part of the beam report. For example, the WTRU may report the selected reporting method in a dedicated field (e.g., known to both WTRU and gNB) of size log₂ (|set of reporting methods|) bits where |⋅| denotes cardinality.

In a solution, the WTRU may indicate selected reporting method based on type of resources (e.g., PUCCH, PUSCH) used for transmitting beam reports. For example, the WTRU may be preconfigured (e.g., via one or more of RRC signaling, MAC-CE indication, and DCI indication) with two possible reporting methods (e.g., first and second reporting methods). The WTRU may also be preconfigured (e.g., via one or more of RRC signaling, MAC-CE indication, DCI indication) to associate reporting method with type of resources to be use for beam reporting. Based on the selected reporting method, for example, the WTRU may select type of resources to transmit beam reports. For example, if the first reporting method is selected, the WTRU may use first type resource (e.g., a PUCCH resource) to transmit beam report. If the second reporting method is selected, the WTRU may use second type resource (e.g., a PUSCH resource) to transmit beam report.

In a solution, the WTRU may indicate reporting method and/or duration in which the selected reporting method is valid. For example, the WTRU may send an indication of the applicable duration in a dedicated field (e.g., known to both WTRU and gNB) of size log₂ (|preconfigured set of durations|) bits where |⋅| denotes cardinality. Until the valid duration expires, in some examples, the WTRU may not report the reporting method selected (e.g., to reduce reporting or signaling overhead, etc.). Once the applicable duration expires, the WTRU may include a reporting method (e.g., selected reporting method) in another (e.g., subsequent) beam report. For example, the WTRU may indicate applicable duration out of a preconfigured (e.g., via one or more of RRC signaling, MAC-CE indication, and DCI indication) set of durations (e.g., first duration, second duration, etc.).

The WTRU may select a duration out of a set of preconfigured durations based on a preconfigured (e.g., via one or more of RRC signaling, MAC-CE indication, DCI indication) rule. For example, WTRU may select an application duration for a selected reporting method based on mobility. For example, if WTRU speed is greater than a preconfigured (e.g., via one or more of RRC signaling, MAC-CE indication, and DCI indication) threshold speed, the WTRU may select a first duration. If WTRU speed less than or equal to the preconfigured (e.g., via one or more of RRC signaling, MAC-CE indication, DCI indication) threshold speed (e.g., and/or another preconfigured threshold speed), then the WTRU may select a second duration.

Based on the reporting method the WTRU selected (e.g., for CRI based reporting where WTRU indicates CRI or SSBRI of each beam included in the report), the WTRU may report number of beams included in the beam report (e.g., WTRU may report number of beams in a dedicated field known to both gNB and WTRU). For example, when there is no configured (e.g., via one or more of RRC signaling, MAC-CE indication, DCI indication) limit on maximum number of beams to be included in a beam report, the WTRU may report number of beams included in the beam report in a dedicated field (e.g., known to both gNB and UE) in the beam report by using log 2(|beam resource set|) bits. Alternatively or additionally, for example, if the maximum number (N_max) of beams to be included in beam report is preconfigured (e.g., via one or more of RRC signaling, MAC-CE indication, DCI indication) and/or known to both gNB and WTRU, the WTRU may report number of beams included in the beam report in a dedicated field (e.g., known to both gNB and UE) in the beam report by using log 2(|N_max|) bits.

1. A Wireless Transmit/Receive Unit (WTRU) comprising:
a processor configured to:
receive configuration information associated with at least one of a prediction set of beams or a measurement set of beams;
select, based on the configuration information, a beam subset from the at least one of the prediction set or the measurement set;
select, from a plurality of reporting methods, a reporting method for reporting the beam subset based on at least one of: (i) a reporting configuration associated with a base station, (ii) payload sizes associated with the plurality of reporting methods, (iii) network coverage at the WTRU, (iv) a size of the beam subset, or (v) content of the beam subset; and
send, using the selected reporting method, one or more reports associated with the selected beam subset.

2. The WTRU of claim 1, wherein the processor is further configured to select the reporting method based on one or more thresholds.

3. The WTRU of claim 1, wherein the received configuration information indicates one or more reference signal (RS) resource configurations for the at least one of the prediction set or the measurement set.

4. The WTRU of claim 1, wherein the received configuration information indicates one or more of: a threshold for beam selection, a threshold for reporting method selection, or a maximum number of beams to be selected from the at least one of the prediction set or the measurement set as the beam subset.

5. The WTRU of claim 1, wherein the processor is further configured to:
collect or predict reference signal (RS) measurements for the prediction set of beams or the measurement set of beams, wherein the one or more reports indicate at least one of the collected or predicted RS measurements.

6. The WTRU of claim 1, wherein the processor is further configured to:
receive the reporting configuration of the base station, wherein the reporting configuration indicates to the WTRU to use the selected reporting method for sending reports to the base station.

7. The WTRU of claim 1, wherein the processor is further configured to:
select the reporting method based on a first payload associated with sending the one or more reports using the selected reporting method being less than a second payload associated with sending the one or more reports using a different reporting method of the plurality of reporting methods.

8. The WTRU of claim 1, wherein the processor is further configured to:
select a first reporting method for sending the one or more reports based on the size of the beam subset being greater than a first threshold and less than a second threshold; and
select a second reporting method for sending the one or more reports based on the size of the beam subset being greater than the second threshold, wherein the size of the beam subset corresponds to a number of beams in the beam subset.

9. The WTRU of claim 1, wherein the processor is further configured to:
select the reporting method based on a signal-to-noise-ratio (SNR) at the WTRU being less than a threshold SNR, wherein the SNR is indicative of the network coverage at the WTRU.

10. The WTRU of claim 1, wherein the processor is further configured to:
select a first reporting method for sending the one or more reports based on a beam quality associated with one or more beams in the beam subset being greater than a threshold; and
select a second reporting method for sending the one or more reports based on the beam quality being less than the threshold, wherein the content of the beam subset corresponds to the one or more beams in the beam subset.

11. A method performed by a Wireless Transmit/Receive Unit (WTRU), the method comprising:
receiving configuration information associated with at least one of a prediction set of beams or a measurement set of beams;
selecting, based on the configuration information, a beam subset from the at least one of the prediction set or the measurement set;
selecting, from a plurality of reporting methods, a reporting method for reporting the beam subset based on at least one of: (i) a reporting configuration associated with a base station, (ii) payload sizes associated with the plurality of reporting methods, (iii) network coverage at the WTRU, (iv) a size of the beam subset, or (v) content of the beam subset; and
sending, using the selected reporting method, one or more reports associated with the selected beam subset.

12. The method of claim 11, further comprising selecting the reporting method further based on one or more thresholds.

13. The method of claim 11, wherein the received configuration information indicates one or more reference signal (RS) resource configurations for the at least one of the prediction set or the measurement set.

14. The method of claim 11, wherein the received configuration information indicates one or more of: a threshold for beam selection, a threshold for reporting method selection, or a maximum number of beams to be selected from the at least one of the prediction set or the measurement set as the beam subset.

15. The method of claim 11, further comprising:
collecting or predicting reference signal (RS) measurements for the prediction set of beams or the measurement set of beams, wherein the one or more reports indicate at least one of the collected or predicted RS measurements.

16. The method of claim 11, further comprising:
receiving the reporting configuration of the base station, wherein the reporting configuration indicates to the WTRU to use the selected reporting method for sending reports to the base station.

17. The method of claim 11, further comprising:
selecting the reporting method based on a first payload associated with sending the one or more reports using the selected reporting method being less than a second payload associated with sending the one or more reports using a different reporting method of the plurality of reporting methods.

18. The method of claim 11, further comprising:
selecting a first reporting method for sending the one or more reports based on the size of the beam subset being greater than a first threshold and less than a second threshold; and
selecting a second reporting method for sending the one or more reports based on the size of the beam subset being greater than the second threshold, wherein the size of the beam subset corresponds to a number of beams in the beam subset.

19. The method of claim 11, further comprising:
selecting the reporting method based on a signal-to-noise-ratio (SNR) at the WTRU being less than a threshold SNR, wherein the SNR is indicative of the network coverage at the WTRU.

20. The method of claim 11, further comprising:
selecting a first reporting method for sending the one or more reports based on a beam quality associated with one or more beams in the beam subset being greater than a threshold; and
selecting a second reporting method for sending the one or more reports based on the beam quality being less than the threshold, wherein the content of the beam subset corresponds to the one or more beams in the beam subset.
